(19) United States
(12) Patent Application Publication
(10) Pub. No.: US 2005/0061843 A1
(43) Pub. Date: Mar. 24, 2005

(54) Carbage

(76) Inventor: Eric Rappaport, Clifton Park, NY (US)

Correspondence Address: Eric Rappaport, 13 Patroon Way, Cliffton Park, NY, 12065, US

(21) Appl. No.: 10/421,033

(22) Filed: Sep. 11, 2003

(51) Int. Cl. B60R 7/00; B60R 9/00; B60R 11/00

(52) U.S. Cl. 224/547

(57) ABSTRACT

The art/drawings are the same as the original which was submitted Feb. 7, 2003. The only change is that it has been placed on white background paper and has a margin of 1″ around the entire perimeter so that the drawings comply with 37CFR 1.84 and 37 CFR 1.121.

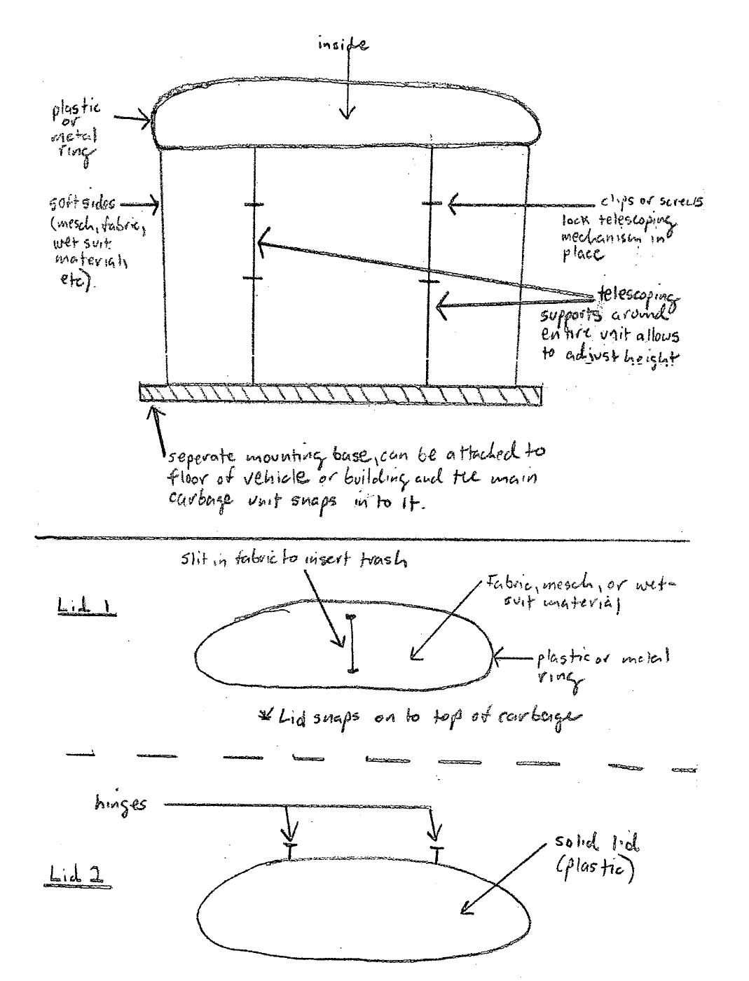

Carbage is a soft-sided trash receptacle. The sides may be made of fabric, mesh, wet suit material, etc. Telescoping supports surround the unit allowing for adjustable height. Telescoping unit may be made of plastic or metal with clips or screws to lock the telescope at desired height. At the top and bottom of the unit is a plastic or metal ring which the telescoping mechanism may attach. There is a separate detachable mounting unit so that the receptacle may be mounted to the floor of vehicle and/or building to prevent movement. Carbage unit will snap in to the mounting unit and will have a release mechanism as well.

Two different lids will be available. The first will have a plastic or metal outer ring. The top of the lid will be made of fabric, mesh, wet suit material, etc. There will be a slit in the middle of this fabric to allow insertion of waste material. The second lid will be made of a solid material such as plastic. It will be hinged to the main unit and opens easily for the insertion of waste material.

The carbage unit & lids may be made in almost any geometrical shape such as, but not limited to: round, rectangle, square, oval, triangle, etc.

II. We claim that carbage is the only trash receptacle that may be built into or added to a vehicle after market that is collapseabe to completely hide from view (in full collapsed position) and may be expanded to desired height and need.

III. We claim that carbage may be built in to vehicle at time of manufacturer and/or be attached to a vehicle aftermarket.
